(19) United States
(12) Patent Application Publication
(10) Pub. No.: US 2010/0108522 A1
(43) Pub. Date: May 6, 2010

(54) BIOELECTRICAL TREATMENT OF XENOBIOTICS

(75) Inventors: John D. Coates, Walnut Creek, CA (US); Cameron J. Thrash, Oakland, CA (US)

Correspondence Address: Weaver Austin Villeneuve & Sampson LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 12/514,884

(22) PCT Filed: Nov. 27, 2007
(86) PCT No.: PCT/US07/85656

§ 371 Date: Dec. 18, 2009

Related U.S. Application Data
(60) Provisional application No. 60/867,393, filed on Nov. 27, 2006.
(60) Provisional application No. 60/975,584, filed on Sep. 27, 2007.

(51) Int. Cl. C02F 11/02

(52) U.S. Cl. 204/665; 204/666

(57) ABSTRACT

The present invention provides a system for remediation of a xenobiotic in a liquid. The system comprises: a first chamber having a first port and a second port, a first electrode in the first chamber, a second electrode is in electrical communication with the first electrode and with a voltage source, wherein the first electrode is an anode and the second electrode is a cathode or the first electrode is a cathode and the second electrode is an anode. The system uses an electric current to provide an electron acceptor or electron donor for a microorganism capable of remediating the xenobiotic.

### CROSS REFERENCE TO RELATED APPLICATIONS

This application claims priority to U.S. Provisional Patent Application Ser. No. 60/867,393, filed Nov. 27, 2006, and U.S. Provisional Patent Application Ser. No. 60/975,584, filed Sep. 27, 2007, which are hereby incorporated in their entireties by reference.

### STATEMENT OF GOVERNMENTAL SUPPORT

The invention described and claimed herein was made in part utilizing funds supplied by the U.S. Department of Energy (DOE) under Contract No. DE-AC02-05CH11231 through the DOE Laboratory Directed Research and Development (LDRD) program. The government has certain rights in this invention.

### BACKGROUND OF THE INVENTION

An extensive range of xenobiotics can be treated through activities of microorganisms and completely converted into benign products. Water treatment plants use such activities, such as aerobic metabolism, as a primary process for the treatment of a diverse range of household, industrial, and agricultural waste streams. From this industry comes the concept of bioremediation in which target microbial metabolism can be stimulated for the treatment of specific groups of contaminants including, gasoline, monoaromatic hydrocarbon, chlorinated solvents, polychlorinated benzenes, heavy metals, radionuclides, pesticides, herbicides, and textile dyes. In all cases, microbial metabolism of these compounds is generally limited by the availability of suitable electron donors or electron acceptors depending on the catabolism that is the focus of the treatment. To overcome this limitation, most water treatment facilities and bioremediation strategies are designed to maximize the supply of these critical nutrients to the relevant microbial communities. Oxygen is the preferential electron acceptor in most cases because of the thermodynamics favorability of the biodegradation (oxidation) of many organics coupled to aerobic respiration and because molecular oxygen is used as a co-substrate for mono- and di-oxygenase enzymes which are often the primary form of attack used by microorganisms to breakdown complex organic molecules. However, due to the limited solubility of oxygen, supplying active microbial communities with sufficient oxygen to continuously degrade large concentrations of organic contaminants requires the installation of bulk energy consuming heavy equipment such as air blowers, spargers, and mixers. In contrast, many other contaminants are potentially degraded and transformed into innocuous end products through electron donors to dissimilatorily reduce the target contaminant to a more benign form. Examples of this would be the bioreduction of carcinogenic chlorinated solvents to innocuous ethane, or the bioreduction of the radioactive soluble hexavalent uranium to an insoluble tetravalent form that can be removed through filtration. In such instances, the supply of suitable electron donors is the critical issue as an inappropriate selection or an excess addition can cause biofouling, water quality issues, distribution pipeline corrosion, and the production of carcinogenic trihalomethanes (THMs).

Biological treatment of organic and inorganic wastes is often hampered by a limitation in the supply of suitable electron donors or electron acceptors to the active microbial populations.

One such inorganic waste is percholorate. Perchlorate (ClO₄⁻), a soluble anion, is known to affect mammalian thyroid hormone production potentially leading to neonatal neuropsychological development deficiencies. It is predominantly a synthetic compound with a broad assortment of industrial applications ranging from pyrotechnics to lubricating oils. Ammonium perchlorate represents 90% of all perchlorate salts manufactured and is used as an energetics booster or oxidant in solid rocket fuels and munitions. Its presence in the environment primarily results from legal historical discharge of unregulated manufacturing waste streams, disposal pond leachate, and the periodic servicing of military inventories. Although a powerful oxidant, under most environmental conditions perchlorate is quite stable owing to the high energy of activation associated with its reduction. Perchlorate salts readily dissociate in aqueous phases because of the large molecular volume and single anionic charge. Furthermore, perchlorate does not significantly absorb to soils or sediments and, in the absence of any biological interactions, its mobility and fate are largely influenced by the hydrology of the environment.

Remediation efforts for perchlorate contamination have focused primarily on microbial reduction. Many recent studies have demonstrated that specialized microorganisms have evolved that can grow by the anaerobic reductive dissimilation of perchlorate into innocuous chloride. More than forty dissimilatory perchlorate-reducing bacteria (DPRB) are now in pure culture and organisms capable of this metabolism are known to be ubiquitous in soil and sedimentary environments, making in-situ treatments relatively straightforward.

Several bioreactor designs are available for the ex-situ biological attenuation of perchlorate-contaminated waters. Recently, some of these reactor designs were approved by the California Department of Health Services for application in the treatment of perchlorate contaminated drinking water (URL http://www.safedrinkingwater.com/archive/sdwn051502.htm). However, these systems are dependent on the continual addition of a chemical electron donor to sustain microbial activity and are subject to biofouling issues. Furthermore, residual labile electron donor in the reactor effluent can stimulate microbial growth in water distribution systems and contribute to the formation of potentially toxic THM during disinfection by chlorination.

To overcome these problems, chemolithotrophic perchlorate-reducing bioreactors utilizing H₂ as an electron donor have been proposed. However, in bulk quantities H₂ is difficult to handle and is perceived publicly as representing a significant disaster threat due to its inherently explosive nature. Alternative inorganic electron donors including Fe(II) or H₂₅ may offer a more practical approach, however, regular additions of these compounds to bioreactors would still be required. Furthermore, H₂₅ is a malodorous toxic compound which can cause corrosion issues, while the particulate ferric (hydr)oxides resulting from Fe(II) oxidation result in unpleasant taste and odor, clogged pump- and treatment systems, and anodic corrosion of steel pipes and distribution lines.

It would be very useful to have another means of supplying electrons to the functional microbial populations such as DPRB to avoid the issues associated with chemical electron donors. A negatively charged electrode (cathode) in the working chamber of a bioelectrical reactor (BER) could act as an electron donor for microbial perchlorate reduction. The DPRB could use the electrons on the electrode surface as a source of reducing equivalents for perchlorate reduction, while assimilating carbon from CO₂ or alternative available organic sources. Such a process would have the advantage of long-term, low-maintenance operation while limiting the injection of additional chemicals into the water treatment process. This would negate downstream issues associated with corrosion and biofouling of distribution systems and the production of toxic disinfection byproducts.

### BRIEF DESCRIPTION OF THE INVENTION

The present invention provides a system for remediation of a xenobiotic in a liquid. The system uses an electric current to provide an electron acceptor or electron donor for a microorganism capable of remediating the xenobiotic.

The system comprises: a first chamber having a first port and a second port; a first electrode in the first chamber, a second electrode is in electrical communication with the first electrode and with a voltage source, wherein the first electrode is an anode and the second electrode is a cathode or the first electrode is a cathode and the second electrode is an anode. Optionally, the first electrode is interposed between the first port and the second port. When in use, the first chamber further comprises a first liquid containing a first xenobiotic that is in need of removal.

The present invention also provides for such a system that further comprises a second chamber having a third port and a fourth port. Optionally, the second electrode is in the second chamber and is interposed between the third port and the fourth port. When in use, the second chamber further comprises a second liquid containing a second xenobiotic that is in need of removal. The first liquid and the second liquid are in electrical communication. The first xenobiotic and the second xenobiotic can be the same or different xenobiotic.

The present invention further provides for a method of remediating a xenobiotic in a liquid, comprising: providing a system of the present invention, applying a voltage to the first electrode, and flowing liquid into the first chamber such that the liquid is in contact with first electrode.

The present invention further provides for a method of remediating a xenobiotic in a liquid, comprising: providing a system of the present invention comprising the first and second chambers, applying a voltage to the first electrode, flowing a first liquid into the first chamber such that the liquid is in contact with first electrode, and flowing a second liquid into the second chamber such that the second liquid is in contact with second electrode; wherein the first and second liquids are in electrical communication. Optionally, the first liquid flows out of the first chamber and into the second chamber as the second liquid.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a diagram that shows a two-chamber system for remediating a xenobiotic, such as perchlorate, according to an embodiment of the invention.

FIG. 2 is a diagram that shows a one-chamber system for remediating a xenobiotic, such as perchlorate, according to an embodiment of the invention.

FIG. 3 outlines steps in a method to reduce or eliminate a xenobiotic, such as perchlorate, in a liquid using a bioelectrical reaction.

FIG. 4 is a graph of perchlorate reduction as a function of time for the novel method outlined in FIG. 3, an open circuit control, and a standard culturing method using a full scale biological treatment reactor.

FIG. 5 (Panels A and B) shows immunofluorescence micrographs that indicate the presence of an active perchlorate reducing population attached to the surface of the cathode.

FIG. 6 shows the position of the VDY bacteria as closely to Dechlorospirillum anomalous strain WD in the alpha subclass of the proteobacteria.

FIG. 7 is a graph of perchlorate reduction as a function of time for an open circuit control, and for perchlorate-contaminated liquids inoculated with strain VDY both with and without the addition of AQDS.

FIG. 8 shows a one-chamber system (Panel A) and a two-chamber system (Panel B) of the invention.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a peptide” includes a plurality of such peptides, and so forth.

These and other objects, advantages, and features of the invention will become apparent to those persons skilled in the art upon reading the details of the invention as more fully described below.

The present invention offers several significant advantages, including one or more of the following: (1) significant lower energy requirements for operation; (2) ease of online monitoring; (3) no chemical electron donor or electron acceptor additions are required; (4) broad applicability to a range of contaminants; (5) contaminants can be treated individually or in mixtures; (6) contaminants requiring oxidative and reductive biological metabolisms can be treated in a single system; and (7) minimum impact on the water geochemistry.

One aspect of the present invention take advantage of the electrolysis of water to supply oxygen as a suitable electron acceptor or hydrogen as a suitable electron donor both of which are bioavailable for the stimulation of appropriate microbial activities.

One aspect of the present invention is that the system when in operation, or the method when practiced, in a steady state the microorganisms produce little or no biomass. As such, the system when in operation, or the method when practiced, does not require removal of any excess microorganisms. The growth of the microorganisms can be controlled by adjusting the electric current provided to the electrodes to control the amount of electron acceptors and donors available to the microorganisms, such that the electric current to achieve the steady state of little or no biomass produced is determined and maintained.

One aspect of the invention is the modification of a xenobiotic into a modified form. Typically, the xenobiotic is an ion or compound that is toxic, mutagenic, carcinogenic, teratogenic, and/or caustic agent that is harmful to an ecosystem and to living organisms, for example, humans, animals, and/or plants. Typically, the xenobiotic is a pollutant that to be removed from the environment or is the by-product of an industrial process. Examples of xenobiotics include gasoline, monoaromatic hydrocarbon, chlorinated solvents, polychlorinated benzenes, heavy metals, radionuclides, pesticides, herbicides, and textile dyes

The xenobiotic can be an organic compound, such as a halogenated hydrocarbon, or an inorganic ion, such as perchlorate, chlorate, or the like. The halogenated hydrocarbon can be a halogenated alkane, such as trihalomethane (THM), tetrachloroethne (PCE), trichloroethane (TCE), and the like, or a halogenated aromatic compound, such as trichlorobenzene (TCB), halogenated dioxin (such as 2,3,7,8-tetrachlorodibenzo-p-dioxin (TCDD)), and the like. The liquid to be remediated may contain a plurality of xenobiotics.

A variety of suitable microorganism can be used in the present invention. A suitable microorganism is a prokaryote, such as eubacteria or an archaebacteria, or a fungus. The suitability of the microorganism depends on the xenobiotic that is to be rendered non-toxic. The microorganism can be introduced into the system as (a) a pure culture, (b) a mixed culture, or (c) a sample obtained from nature, wherein it is known or not known what bacterial species are in the sample. The system can be set up such that microorganism species that are able to remediate the xenobiotic are favored and thus are enriched in the system. The microorganism enriched by such a method can be furthered isolated, characterized, and identified.

The microorganisms suitable for this invention can be any microorganism that is capable of converting a xenobiotic into the modified form. The modified xenobiotic can be non-toxic or less toxic (as compared to the unmodified xenobiotic) to humans and/or animals, or it can be in a different form, such as conversion from an aqueous form into an insoluble or solid form, that can be easily separated from the contaminated liquid.

Bacteria of the genus Dehalococcoides are used in the invention for the oxidation or reduction of chlorinated benzenes, such as tetrachloroethene (PCE) and/or trichloroethene (TCE). PCE and TCE can be transformed to less chlorinated ethenes in anaerobic cometabolic processes mediated by methanogenic, homoacetogenic, and sulfate-reducing microorganisms. Dehalococcoides sp. strain CBDB1 is able to grow with trichlorobenzene (TCB), hydrogen, and acetate, indicating that it conserves energy by using TCB as the terminal electron acceptor in a respiratory process. Strain CBDB1 can also dehalogenate halogenated dioxins, such as dechlorinate chlorinated dioxins.

Table 1 provides a list of microorganisms and xenobiotics for which the corresponding microorganism is capable of oxidizing or reducing to a less or non-toxic form.

| Microorganism | Xenobiotic |
|---|---|
| Dehalococcoides ethanogenes | PCE |
| Dechloromonas aromatic | Benzene, toluene, ethylbenzene, xylene, |
| | perchlorate, chlorate |
| Dehalococcoides sp. | PCE, TCE, TCB, halogenated dioxin, |
| (such as strain CBDB1) | chlorinated dioxin |
| Pseudomonas sp. | Monoaromatic and/or polycyclic |
| | hydrocarbons |
| Geobacter sp. | Uranium |
| (such as G. metallireducens) | |
| Dechloromonas sp. | Perchlorate, chlorate |
| Azospira sp. | Perchlorate, chlorate |
| Dechlorospirillum sp. | Perchlorate, chlorate |

One aspect of the invention involves using a system for remediation of a xenobiotic in a liquid. Typically, the liquid is an aqueous solution or suspension containing the xenobiotic in an aqueous form, or the xenobiotic is in a liquid form that is miscible with water. Typically the liquid is not capable of killing the microorganism(s) in the system. The liquid that flows through the system is obtained as is directly from the environment, or is first treated (such as filtered to remove solid particles) prior in introduction into the system, or is a liquid produced from washing a solid medium contaminated with the xenobiotic (such as the resulting solution obtained from washing contaminated soil with water). If the liquid in its original form is capable of killing the microorganism(s) in the system, it can diluted by the addition of water or any other suitable solution or liquid to render it incapable of killing the microorganism(s) in the system.

The system comprises: a first chamber having a first port and a second port; a first electrode in the first chamber, the first electrode interposed between the first port and the second port; a second electrode is in electrical communication with the first electrode and with a voltage source, wherein the first electrode is an anode and the second electrode is a cathode or the first electrode is a cathode and the second electrode is an anode.

In some embodiments, the system further comprises a second chamber having a third port and a fourth port, wherein the second electrode is in the second chamber and is interposed between the third port and the fourth port.

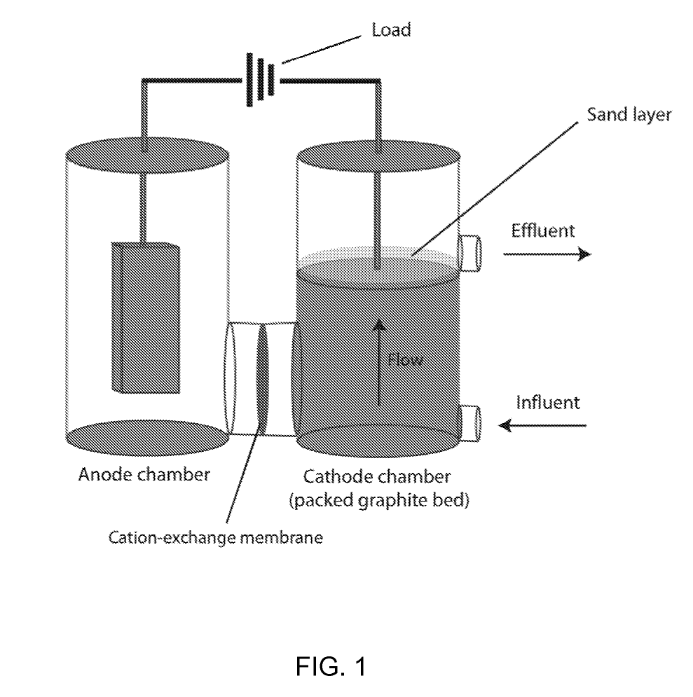

In some embodiments, the first chamber is in fluid communication with the second chamber. In some embodiments, the fluid communication is through one or more cation-exchange membranes. In some embodiments, the second port is in fluid communication with the third port. The liquid can flow directly from the second port to the third port. In some embodiments, the liquid entering the first port and the liquid entering the third port are from different sources. In some embodiments, the fluid communication is such that fluid enters the system through the first port; then flows through the first chamber, the second port, the third port, and the second chamber; and then exits the system through the fourth port. Exemplary systems are shown in FIGS. 1, 2 and 8.

In some embodiments, the system further comprises a first microbial culture residing in the first chamber, and optionally a second microbial culture residing in the second chamber. Each microbial culture can be a pure or essentially pure culture, or a mixed culture.

In some embodiments, the first electrode comprises a porous conductive material, and optionally the second electrode also comprises a porous conductive material. The porous conductive material has pores of a size which are sufficiently large for bacteria in general or for specific desired bacteria. Specific desired bacteria are bacterial species which can detoxify specific known xenobiotics in the liquid. The pores can have diameters of about 1 micrometer or more, or about 10 micrometer or more.

In some embodiments, the system further comprise a first pump associated with the first port, the first pump configured to flow liquid through the first chamber and out through the second port, and optionally a second pump associated with the third port, the second pump configured to flow liquid through the second chamber and out through the fourth port.

The voltage source provides a voltage of more than 0 mV. In some embodiments, the voltage source is 50 mV or more, or 100 mV or more, or 200 mV or more. In some embodiments, the voltage source provides a voltage from 200 mV to 1,000 mV. In some embodiments of the invention, the electric current can be occasionally reversed, for example, for more than 0 to 10 minutes out of every 30 minutes to one hour.

In some embodiments, the first chamber further comprises a first organic compound suitable as a carbon source, and the optionally second chamber a second organic compound suitable as a carbon source, wherein the first and second organic compounds can be the same or different organic compounds. The organic compound can be introduced once, periodically, or continuously during the use of the system. The organic compound to be used depends on whether the microbial species used in the system is able to use the organic compound as a carbon source.

In some embodiments, the first chamber further comprises a first electron shuttling compound, and optionally second chamber further comprises a second electron shuttling compound, wherein the first and second electron shuttling compounds can be the same or different electron shuttling compounds.

In some embodiments, the first chamber further comprises a first quinone-containing compound, and the optionally second chamber a second quinone-containing compound, wherein the first and second quinone-containing compounds can be the same or different quinone-containing compounds.

In some embodiments, the invention also provides for a negatively charged electrode (cathode) in the working chamber of a bioelectrical reactor (BER) can be used as an electron donor for microbial perchlorate reduction. The perchlorate-reducing bacteria use the electrons on the electrode surface as a source of reducing equivalents for perchlorate reduction, while assimilating carbon from CO₂ or alternative available organic sources. Such a process has the advantage of long-term, low-maintenance operation while limiting the injection of additional chemicals into the water treatment process. As such, this negates downstream issues associated with corrosion and biofouling of distribution systems and prevents the production of toxic disinfection byproducts.

In some embodiments are illustrated in the context of perchlorate and chlorate remediation in water. The skilled artisan will readily appreciate, however, that the materials and methods disclosed herein will have application in a number of other contexts where remediation of perchlorate and chlorate is desirable.

In some embodiments of the invention, the system comprises a single chamber up-flow bioreactor that contains both an anode and a cathode, i.e., the liquid is flowing against the direction of gravity. Optionally, the chamber can be a down-flow bioreactor, or flowing in any direction independent of the direction of gravity. When the liquid is flowing against the direction of gravity, any means of providing a flow to the liquid can be used, such as the liquid can be pumped using a mechanical pump. The chamber contains a cathode or anode in the form of any suitable conductive material. For example, the cathode or anode can be a packed graphite particle bed, such as a packed graphite particle bed at the bottom of an up-flow bioreactor. There is a sand layer over the graphite bed. There is an anode comprised of a similar matrix near the top of the chamber. The anode is connected to the cathode through a voltage source (or load). An influent port near the bottom of the reaction chamber allows a contaminated liquid to flow upwards through the electrically active electrodes and out of the chamber through an effluent port. The effluent port can be located either between the sand layer and the anode or between the anode and the end of the chamber. Optionally, the anode can be placed at the bottom of the chamber with the cathode at the top of the chamber. The electrical load can result in electrolysis of the water in the chamber producing hydrogen (H₂) at the cathode surface and oxygen (O₂) at the anode surface. These gases are then bioavailable to stimulate the activity of microorganisms to biodegrade or biotransform an extensive range of contaminants into benign end products.

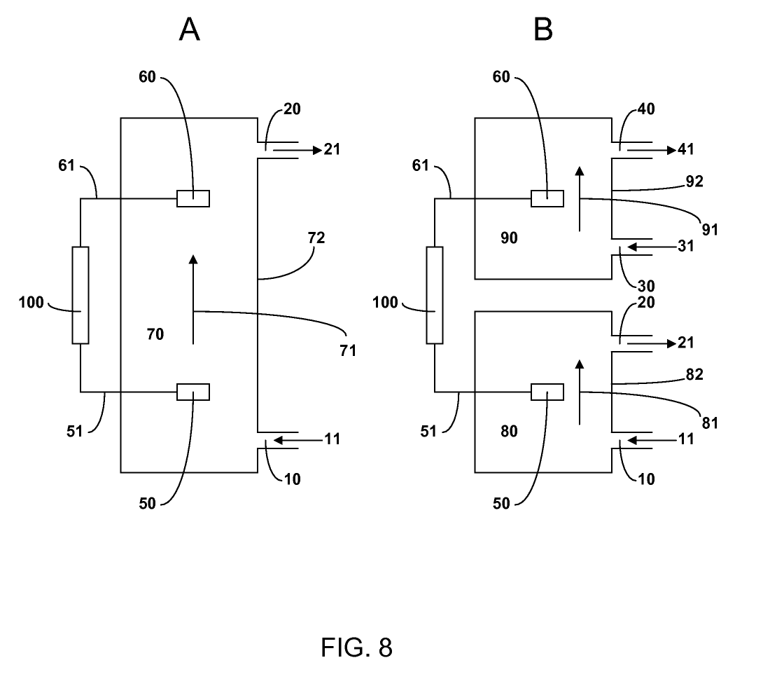

In some embodiments of the invention, the system comprises a chamber (70) at least partially or totally (except for the inlet port (10), outlet port (20) and electrical wires (51 and 61)) enclosed by a chamber wall (72). The use of the system involves the flow of a liquid from outside the chamber through the inlet port (11), thorough the chamber (71) and out of the chamber through the outlet port (21). Within the chamber reside a first electrode (50) and a second electrode (60), wherein the first electrode (50) is interposed between the inlet port (10) and the second electrode (60), and the second electrode (60) is interposed between the first electrode (50) and the outlet port (20). The first electrode (50) and the second electrode (60) are in electrical communication, wherein the first electrode (50) is connected by a means capable of transmitting an electric current (51) to a voltage source (100), and the second electrode (60) is connected by a means capable of transmitting an electric current (61) to the voltage source (100). The first electrode (50) can be the cathode and the second electrode (60) can be the anode, or first electrode (50) can be the anode and the second electrode (60) can be the cathode. (See FIG. 8, Panel A.)

In some embodiments of the invention, the system comprises a first chamber (80) and a second chamber (90). The first chamber (80) is at least partially or totally (except for the first chamber inlet port (10), first chamber outlet port (20) and electrical wire (51)) enclosed by a first chamber wall (82). The second chamber (90) is at least partially or totally (except for the second chamber inlet port (30), second chamber outlet port (40) and electrical wire (61)) enclosed by a second chamber wall (92). The use of the system involves the flow of a liquid from outside the first chamber through the first chamber inlet port (11), through the first chamber (81) and out of the first chamber through the first chamber outlet port (21). There is another flow of liquid from outside the second chamber through the second chamber inlet port (31), through the second chamber (91) and out of the second chamber through the second chamber outlet port (41). The liquid effluent from the first chamber outlet port (20) and the liquid influent going into the second chamber inlet port (30) are in electrical communication, for example, the liquid flows from the first chamber outlet port (20) into the second chamber inlet port (30). Within the first chamber reside a first electrode (50) which is interposed between the first chamber inlet port (10) and the first chamber outlet port (20). Within the second chamber reside a second electrode (60) which is interposed between the second chamber inlet port (30) and the second chamber outlet port (40). The first electrode (50) and the second electrode (60) are in electrical communication, wherein the first electrode (50) is connected by a means capable of transmitting an electric current (51) to a voltage source (100), and the second electrode (60) is connected by a means capable of transmitting an electric current (61) to the voltage source (100). The first electrode (50) can be the cathode and the second electrode (60) can be the anode, or first electrode (50) can be the anode and the second electrode (60) can be the cathode. (See FIG. 8, Panel B.) Optionally, the liquid flows from the first chamber outlet port (20) to the second chamber inlet port (30).

In some embodiments of the invention, the method is a method of remediating perchlorate and chlorate in a liquid, comprising: providing a bioelectrical reaction chamber; introducing a cathode into the chamber; applying a voltage to the cathode; and flowing the liquid into the chamber so that the liquid has at least some contact with cathode. In some embodiments, the method further comprises introducing bacteria into the chamber. In some embodiments, the method further comprises introducing a carbon source into the chamber. In some embodiments, the carbon source is acetate. In some embodiments, the liquid comprises water. In some embodiments, the cathode comprises a porous conductive material. In some embodiments, the porous conductive material comprises a packed graphite particle bed. In some embodiments, the voltage is at least about −200 millivolts. In some embodiments, the voltage is between about −200 and −1000 millivolts. In some embodiments, the method further comprises adding an electron shuttling compound to the reaction chamber. In some embodiments, the method further comprises adding a quinone-containing compound to the reaction chamber.

In some embodiments of the invention, the system is a system for remediation of perchlorate in a liquid, comprising: a first reaction chamber having a first port and a second port; a cathode in the first chamber, the cathode interposed between the first port and the second port; and an anode in electrical communication with the cathode and with a voltage source. In some embodiments, the cathode comprises a porous conductive material. In some embodiments, the anode is positioned in the first reaction chamber between the cathode and the second port. In some embodiments, the second port is positioned in the first reaction chamber between the cathode and the anode. In some embodiments, the system further comprises a pump associated with the first port, the pump configured to flow liquid through the system and out through the second port. In some embodiments, the system further comprises a second chamber in communication with the first chamber through a cation-exchange membrane. In some embodiments, the anode is positioned in the second chamber.

The embodiments are illustrated in the context of perchlorate and chlorate remediation in water. The skilled artisan will readily appreciate, however, that the materials and methods disclosed herein will have application in a number of other contexts where remediation of any other xenobiotic is desired, or other contexts where remediation of perchlorate and chlorate is desirable.

The aforementioned needs are satisfied by the process of the present invention which includes both a system and a process for perchlorate remediation without the use of additional chemicals.

FIG. 1 is a diagram that shows a system for remediation of a xenobiotic, such as perchlorate, according to an embodiment of the invention. An up-flow reactor has two chambers; an anode chamber and a cathode chamber. The chambers are connected to one another through a cation-exchange membrane. The cathode chamber contains a cathode in the form of a packed graphite particle bed at the bottom. There is a sand layer over the graphite bed. An influent port near the bottom of the reaction chamber allows a contaminated liquid to flow upwards through the graphite bed, through the sand layer and out of the chamber through an effluent port. In an alternate embodiment, the direction of the electric current is reversed, and cathode and anodes (and their respective chambers) are switched, such that the influent flows into the anode chamber. In another embodiment, the flow within the cathode chamber (or anode chamber) may be any direction relative to the direction of gravity, such as a down-flow.

The anode chamber contains water and an anode. The anode can be made of any electrically conductive material, such as iron, platinum, or graphite. The anode is connected to the graphite bed through a voltage source (load). A voltage can be applied to the graphite cathode and turned off as desired. In some arrangements, a silver reference electrode is also used.

An influent port near the bottom of the cathode or reaction chamber allows a liquid to flow upwards through the graphite bed, through the sand layer and out of the chamber through an effluent port.

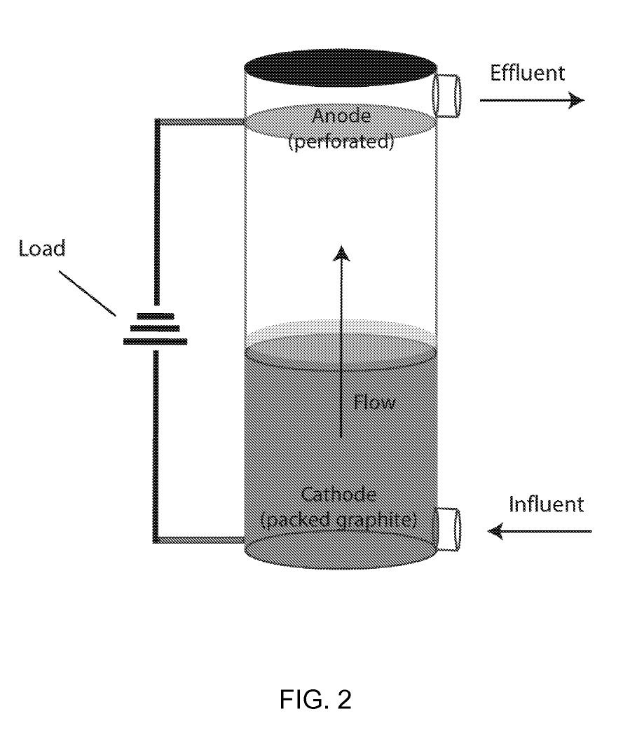

FIG. 2 is a diagram that shows a system for remediation of a xenobiotic, such as perchlorate, according to another embodiment of the invention. An up-flow reactor has only one chamber, which contains both an anode and a cathode. The chamber contains a cathode in the form of a packed graphite particle bed at the bottom. There is a sand layer over the graphite bed. There is an anode near the top of the chamber. The anode is connected to the graphite bed through a voltage source (load). In some arrangements, the anode is perforated. A voltage can be applied to the graphite cathode and turned off as desired. In some arrangements, a silver reference electrode is also used. An influent port near the bottom of the reaction chamber allows a contaminated liquid to flow upwards through the graphite bed, through the sand layer and out of the chamber through an effluent port. The effluent port can be located either between the sand layer and the anode (not shown) or between the anode and the end of the chamber (as shown). In an alternate embodiment, the direction of the electric current is reversed, and cathode and anodes are switched, such that the influent flows first to the anode. In another embodiment, the flow within the chamber may be any direction relative to the direction of gravity, such as a down-flow.

The exemplary systems shown in FIGS. 1, 2, and 8 can also include any number of additional openings, as desired. For example, it may be desirable to have the tops of the chambers open in order to facilitate placement of chamber components or inflow of a gas such as N₂, Ar, or He. Such openings can be sealed with watertight fittings, such as butyl stoppers and aluminum crimp seals. Wires to connect the cathode to the voltage source and to the anode can be threaded through such fittings.

The exemplary systems shown in FIGS. 1 and 2 make good use of gravity to hold the graphite beds in place. The sand layer over the graphite bed helps to keep graphite particles from flowing out of the cathode as a liquid flows upward. Other arrangements are possible. The reaction chamber can be turned upside down or arranged at any angle relative to the vertical, as desired. For arrangements where gravity and sand cannot be depended upon to keep the graphite bed in place (or might even work against same), modifications to the system can be made. In one example, the sand layer is either held in place or replaced by a membrane attached to the sides of the reaction chamber. For arrangements where the reaction chamber is turned upside down relative to the drawings in FIGS. 1 and 2, the liquid flow is aided by gravity. One or more of these features can similarly be incorporated into the systems shown in FIG. 8.

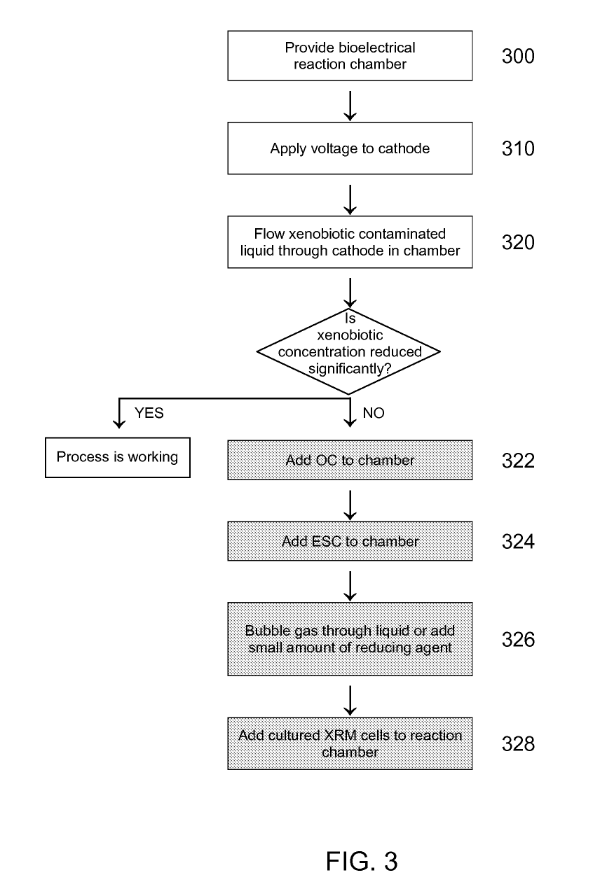

FIG. 3 outlines the steps in a method of reducing or eliminating a xenobiotic, such as perchlorate, in water using a bioelectrical reaction chamber. The white boxes 300, 330, 350 indicate the basic steps in the method. The shaded boxes 310, 320, 340 indicate additional optional steps in the method.

First a bioelectrical reaction chamber, examples of which are shown in FIGS. 1 and 2, is provided 300. In the second step 310, a voltage is applied to the cathode (or anode) in the reaction chamber. In one arrangement, the voltage is −500 mV relative to a standardized silver electrode. In other arrangements, the voltage can range from about −200 mV to about −1000 mV. In yet other arrangements, the voltage can have values even greater than −1000 mV. Voltages large enough to kill the beneficial bacteria provide a practical limit. In general, it is useful to use larger (more negative) voltages with higher contaminated liquid flow rates. In the third step 320, a xenobiotic (such as perchlorate and/or chlorate) contaminated liquid is flowed through the cathode (or anode) in the reaction chamber.

Next, it is determined whether the xenobiotic (such as perchlorate and/or chlorate) concentration in the contaminated liquid has been reduced significantly (or eliminated). If the answer is yes, xenobiotic reduction is satisfactory, the process is working effectively and the process can continue. If the answer is no, xenobiotic reduction is not satisfactory, there are a few additional steps that can be added to the process, any or all of which can help to effect xenobiotic reduction.

In optional step 322, a suitable organic compound (OC), such as acetate, is added to the chamber as a source of carbon for the xenobiotic-reducing microorganism (XRM), such as dissimilatory perchlorate-reducing bacteria (DPRB), cells in the contaminated liquid. A suitable organic compound is any carbon compound that the microorganism is able to metabolize for growth as a carbon source.

In optional step 324, a suitable electron shuttling compound (ESC), such as 2,6-anthraquinone disulfonate (AQDS), is added to the reaction chamber to improve electron transport between the cathode (or anode) and the microorganism. A suitable ESC is any compound that improves electron transport between the cathode (or anode) and the microorganism, and is not toxic to the microorganism.

In optional step 326, a gas, such as nitrogen, argon, or helium, is bubbled through the reaction chamber or a small amount of reducing agent is added to the reaction chamber to ensure anaerobic operation by removing oxygen from the liquid.

In optional step 328, cultured XRM, such as DPRB, cells are added to the reaction chamber. Examples of DPRB cells that can be useful in the embodiments of the invention include Dechloromonas agitata, D. aromatics, Azospira suillum, and Dechlorospirillum anomalous strain VDY, but other known or as yet unknown DPRB cells can be useful as well.

In one embodiment of the invention, an initial, one-time addition of acetate is injected at the same time as the microorganism (either as naturally present in or added to the contaminated liquid), such as bacteria, is added to the reaction chamber. The carbon in the acetate can be used by the microorganism, such as bacteria, to help to establish an initial microbial population in the graphite bed.

While strain VDY has been shown to utilize hydrogen for the reduction of perchlorate, VDY may also utilize electrons directly from the electrode surface or produce an electron shuttling compound to supplement further its metabolism of perchlorate in the cathodic chamber. Regardless of the mechanism of electron transfer from the electrode surface, the ability to remediate perchlorate and chlorate without the addition of additional chemicals, such as AQDS or organic carbon source is advantageous for reducing the cost of treatment as well as for effluent water quality and downstream biofouling.

The embodiments of the invention, as disclosed herein indicate that microbial xenobiotic reduction can be coupled to the removal or donation of electrons from the surface of an electrode. This has important implications with regards to the continuous long-term treatment of xenobiotic contaminated waters and waste streams. Previous methods have used various alternative bioreactor designs, all of which are limited by the requirement for a continuous addition of a suitable chemical electron donor or acceptor. For example, microbial perchlorate reduction is generally inhibited by the presence of O₂ and to some extents nitrate, excess chemical electron donor must be added to biologically remove these components from reactor influents prior to the stimulation of perchlorate reduction. Such additions must be carefully monitored to prevent the presence of residual labile electron donor in the reactor effluent which may result in biofouling of distribution systems and the formation of trihalomethanes. This is especially true if the total electron accepting capacity of the perchlorate present in the contaminated stream is small relative to that of the nitrate and dissolved O₂ content, which is the case for most contaminated waters.

Bioelectrical reduction at the cathode surface, or bioelectrical oxidation at the anode surface, overcomes many of these issues because no chemical electron donor, or electron acceptor, is added to the bioreactor. The embodiments of the invention as described herein demonstrate the exciting potential for the application of bioelectrical reduction for the treatment of xenobiotic contamination without many of the limitations normally associated with bioreactor-based processes.

### EXAMPLES

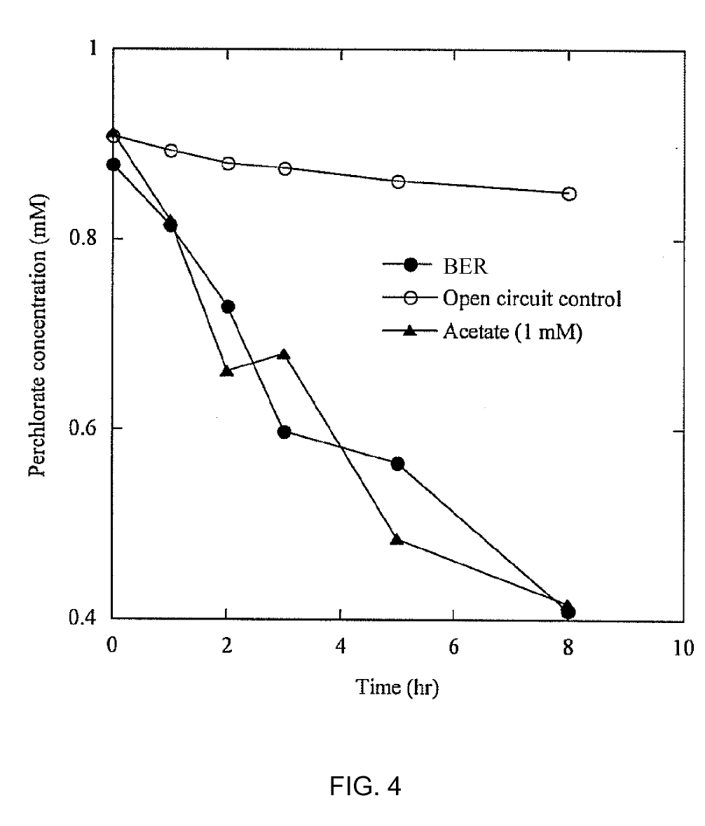

When the system was used to bioremediate perchlorate contaminated liquid, the perchlorate reduction achieved in the novel method outlined in FIG. 3 was equivalent to perchlorate reduction by standard culturing methods and use of full scale biological treatment reactors, as shown by the data in FIG. 4. Active washed cell suspensions of Dechloromonas agitata, D. aromatics, and Azospira suillum reduced 99 mg·L⁻¹ perchlorate over a twenty four hour trial when incubated in the cathodic chamber of the bioelectrical reactor (BER) at a poised potential of −450 mV (relative to the Ag reference electrode) containing 183 mg·L⁻¹ 2,6-anthraquinone disulfonate (AQDS) (closed circles). In all cases, the rate and extent of perchlorate reduction was almost identical to that observed in the positive control to which acetate (59 mg·L⁻¹) was added as the sole electron donor (triangles). In contrast, no significant perchlorate reduction was observed in identical incubations in which the electrical circuit was incomplete (open circuit control—open circles).

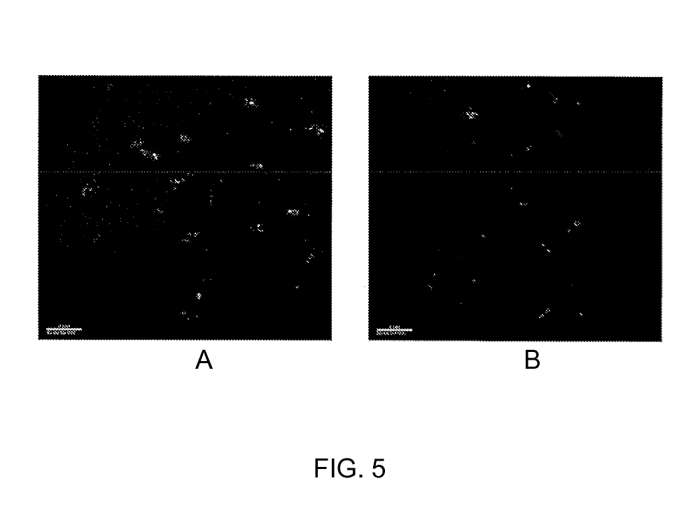

After reducing perchlorate in a groundwater sample from a creek, dot-blot analysis was performed using a specific immunoprobe for the chlorite dismutase (CD), a unique highly conserved enzyme universally present in all DPRB, and it revealed the presence of an active DPRB population in the liquid phase of the BER. Previous studies have shown that this enzyme is expressed by DPRB only when grown on perchlorate or chlorate. Similarly, immunofluorescence microscopy using the same CD-specific IgG indicated the presence of an active perchlorate reducing population attached to the surface of the cathode (FIG. 5A). In contrast, no fluorescent cells were apparent on the graphite surface of the open circuit control (not shown). Visual comparison of the quantity of fluorescent cells on the cathodic surface against the total number of cells stained by propidium iodide indicated that the perchlorate reducing population represented the dominant microbial population attached to the electrode surface (FIG. 5B) suggesting that an enrichment occurred on the cathode surface. This was supported by the results of MPN-PCR enumeration studies performed using primer sets specific for the chlorite dismutase gene (cld). Although these studies revealed the presence of planktonic DPRB in the liquid phase of both the BER and the open circuit control (2.40×10⁴ and 4.30×10³ cells·ml⁻¹ respectively), no DPRB were detected on the electrode surface of the open circuit control, while a significant population (1.71×10⁴ cells·cm²) were present on the electrode surface of the cathodic chamber of the BER. When normalized against total DNA extracted from each of the samples, these results indicated that the DPRB population on the cathode surface (1.02×10⁵ cells/μg) was an order of magnitude greater than the planktonic cells (4.8×10⁴ cells/μg DNA) in the BER and two orders of magnitude greater than the planktonic cells of the open circuit control (8.6×10³ cells/μg DNA).

To identify some of the DPRB present in the BER inoculated creek groundwater, samples (1 g) were scraped from the surface of the cathode after the 70-day incubation and transferred into fresh basal medium with acetate as the electron donor and perchlorate as the sole electron acceptor. After two weeks incubation growth was visually apparent in the primary enrichments of these samples. These enrichments were transferred into fresh basal medium (10% inoculum). Good growth was again observed in the transfer after 24 hours as determined by increase in optical density and microscopic examination. Highly-enriched perchlorate-reducing cultures were obtained by sequential transfer over the following week prior to serial dilution into agar tubes. Small (1-2 mm diameter) pink colonies of consistent morphology were apparent after two weeks of incubation, and a dissimilatory perchlorate-reducing isolate, strain VDY, was identified.

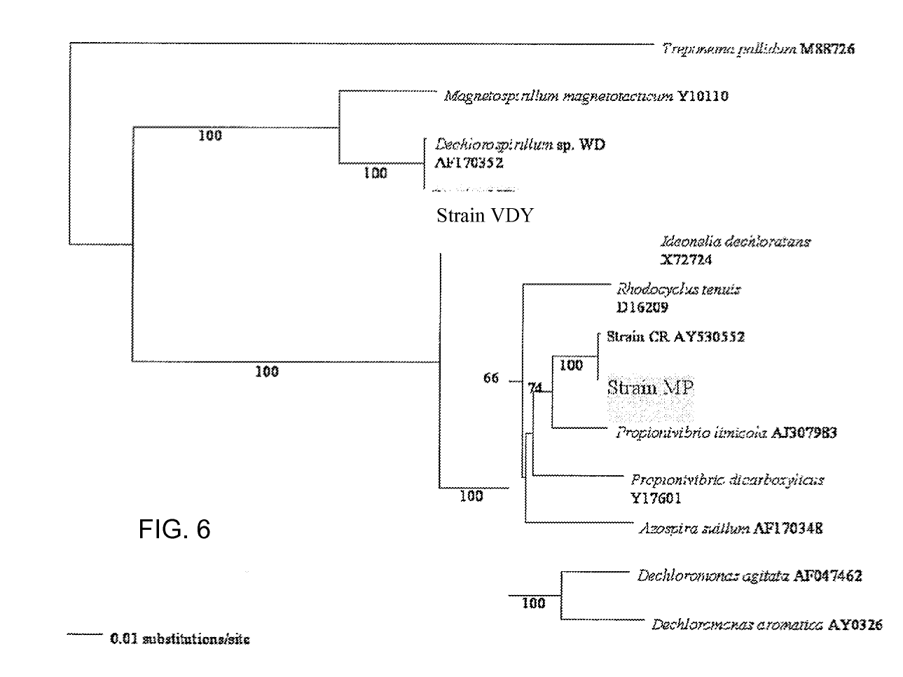

Strain VDY is a gram-negative, facultative anaerobe. Cells, 0.2 μm diameter by 7 μm length showed a consistent spirillum morphology. Strain VDY completely oxidized organic electron donors to CO₂ in the presence of a suitable electron acceptor. Alternatively, strain VDY grew fermentatively in basal medium amended with glucose (1.80 g·L⁻¹), yeast extract (0.1 g·L⁻¹) and casamino acids (0.1 g·L⁻¹). Spores were not visible in wet-mounts by phase contrast microscopy and no growth was observed in fresh acetate-perchlorate medium after pasteurization at 80° C. for 3 minutes. In addition to acetate, strain VDY uses lactate, AH₂DS, ethanol, and H₂ as electron donors and perchlorate, chlorate, nitrate, or O₂ as electron acceptors. Analyses of the 16S rDNA sequences indicated that strain VDY is closely related (>99% 16S rDNA sequence identity) to Dechlorospirillum anomalous strain WD in the alpha subclass of the proteobacteria (FIG. 6).

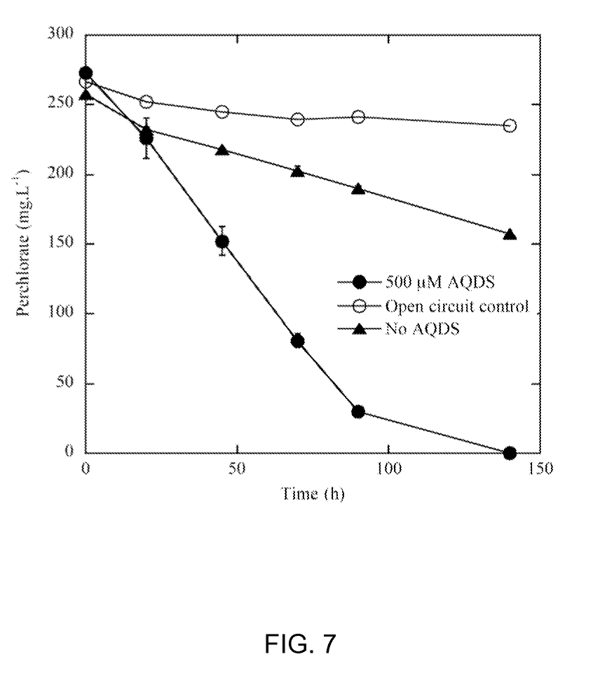

As with the other DPRB tested (D. agitata, D. aromatics, and A. suillum), perchlorate was rapidly removed in the cathodic chamber of a BER poised at −500 mV when inoculated with strain VDY (FIG. 7). Although no significant growth was observed the cell density in the BER remained constant throughout the incubation, while that of the open circuit control rapidly declined (data not shown). No perchlorate removal was observed in the open circuit control (open circles), however, in contrast to the results obtained with the other DPRB, strain VDY was capable of reducing perchlorate in the BER in the absence of the mediator AQDS (triangles), although this removal was significantly slower than that in the BER amended with AQDS (closed circles). Analysis of H₂ production in the BER indicated that under operational conditions 0.78 μg·min⁻¹ were produced through electrolysis of water at the surface of the cathode which is more than enough reducing equivalents to account for the observed reduction of the perchlorate (2 μg·min⁻¹) in the mediatorless BER throughout the incubation assuming a theoretical stoichiometry of

4H₂+ClO₄⁻→Cl⁻+4H₂O

Embodiments of the invention describe surprisingly that electrodes can serve as a primary electron donor for microbial perchlorate reduction. Furthermore, in some arrangements the novel isolate, Dechlorospirillum strain VDY can be especially effective in reducing the amount of perchlorate, chlorate, nitrate, or oxygen in a liquid flowing through the BER. Previous studies have similarly demonstrated the use of an electrode as the primary electron donor for the dissimilatory reduction of nitrate by Geobacter species, fumarate by both Geobacter and Actinobacillus species, hexavalent uranium by Geobacter species, and CO₂ by an undefined enrichment. Furthermore, bioelectrical reduction of soluble iron by a cathode has also been shown to support growth and CO₂ fixation by the iron-oxidizing Acidithiobacillus species.

Clearly, DPRB can use electrons generated at a cathode of a BER. In addition H₂ generated through the electrolysis of water at the cathode surface is likely to play a role in the microbial reduction of perchlorate observed in the BER with amended strain VDY in the absence of AQDS. Although it is known that H₂ is not utilized as an electron donor by the Dechloromonas or Azospira species, physiological characterization revealed that strain VDY could readily use H₂ as an electron donor for respiration.

While strain VDY has been shown to utilize hydrogen for the reduction of perchlorate, VDY may also utilize electrons directly from the electrode surface or produce an electron shuttling compound to supplement further its metabolism of perchlorate in the cathodic chamber. Regardless of the mechanism of electron transfer from the electrode surface, the ability to remediate perchlorate and chlorate without the addition of additional chemicals, such as AQDS or organic carbon source is advantageous for reducing the cost of treatment as well as for effluent water quality and downstream biofouling.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A system for remediation of a xenobiotic in a liquid, comprising:
a first chamber having a first port and a second port;
a first electrode in the first chamber;
a second electrode is in electrical communication with the first electrode and with a voltage source, wherein the first electrode is an anode and the second electrode is a cathode or the first electrode is a cathode and the second electrode is an anode.

2. The system of claim 1, wherein the first chamber further comprises a first liquid containing a first xenobiotic.

3. The system of claim 1, wherein the first chamber further comprises a microorganism capable of converting the first xenobiotic.

4. The system of claim 1, wherein the first electrode interposed between the first port and the second port.

5. The system of claim 1, wherein said second electrode is positioned in the first chamber between the cathode and the second port.

6. The system of claim 1, further comprising a first microbial culture residing in the first chamber.

7. The system of claim 1, wherein the first electrode comprises a porous conductive material.

8. The system of claim 1, further comprising a pump associated with the first port, the pump configured to flow liquid through the system and out through the second port.

9. The system of claim 1, wherein the voltage source provides a voltage between 200 and 1,000 mV.

10. The system of claim 1, wherein the first chamber further comprises an organic compound suitable as a carbon source.

11. The system of claim 1, wherein the first chamber further comprises an electron shuttling compound.

12. The system of claim 1, wherein the first chamber further comprises a quinine-containing compound.

13. The system of claim 1, wherein the xenobiotic is perchlorate or chlorate.

14. The system of claim 1, further comprising a second chamber having a third port and a fourth port, and the second electrode is in the second chamber.

15. The system of claim 14, wherein the second chamber further comprises a second liquid containing a second xenobiotic.

16. The system of claim 15, wherein the second chamber further comprises a population of a second microorganism capable of converting the second xenobiotic.

17. The system of claim 14, wherein the second electrode is interposed between the third port and the fourth port.

18. The system of claim 14, wherein the first chamber is in fluid communication with the second chamber.

19. The system of claim 14, wherein the fluid communication is through a cation-exchange membrane.

20. The system of claim 14, wherein the second port is in fluid communication with the third port.

21. The system of claim 19, wherein the fluid communication is such that fluid enters the system through the first port; then flows through the first chamber, the second port, the third port, and the second chamber; and then exits the system through the fourth port.

22. The system of claim 14, wherein the second electrode comprises a porous conductive material.

23. A method of remediating a xenobiotic in a liquid, comprising, providing a system of claim 1;
applying a voltage to the first electrode;
flowing liquid into the first chamber such that the liquid is in contact with first electrode.

24-34. (canceled)

35. A method of remediating a xenobiotic in a liquid, comprising,
providing a system of claim 14;
applying a voltage to the first electrode and second electrode;
flowing a first liquid into the first chamber such that the first liquid is in contact with first electrode;
flowing a second liquid into the second chamber such that the second liquid is in contact with second electrode.
